(19) United States
(12) Patent Application Publication
(10) Pub. No.: US 2026/0059573 A1
(43) Pub. Date: Feb. 26, 2026

(54) OFFSET RANDOM ACCESS CHANNEL CONFIGURATIONS FOR TIME AND SPATIAL ADAPTATION

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US)

(21) Appl. No.: 18/814,355

(22) Filed: Aug. 23, 2024

(51) Int. Cl. H04W 74/0833; H04W 56/00

(52) U.S. Cl. CPC H04W 74/0833; H04W 56/001

(57) ABSTRACT

Methods, systems, and devices for wireless communications are described. A user equipment (UE) may receive one or more random access configurations indicating a first set of random access occasions from a network entity, and the UE may determine a second set of random access occasions based on the first set of random access occasions. For example, the UE may apply one or more configurations to the first set of random access occasions to obtain the second set of random access occasions. In some examples, applying the configuration may include applying a time offset, a frequency offset, or both, to one or more occasions of the first set of random access occasions. As such, the UE and the network entity may perform the preamble message transmission via a derived random access occasion, and the UE may therefore have additional transmission occasions available for initiating random access procedures.

### FIELD OF TECHNOLOGY

The following relates to wireless communications, including offsets for random access channel configurations to achieve time and spatial adaptations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some examples, a UE may perform a random access procedure to initiate communications with a network, which may involve one or more message transmissions, for example, including a random access preamble.

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first message indicating a first configuration associated with a random access procedure, the first configuration indicating a first set of random access occasions for transmission of a preamble message, determining a second set of random access occasions for the transmission of the preamble message, the second set of random access occasions offset relative to the first set of random access occasions in accordance with a second configuration that is based on the first set of random access occasions, and transmitting the preamble message via at least one random access occasion of the second set of random access occasions.

A UE for wireless communications is described. The UE may include one or more memories storing processor executable code, and one or more processors coupled with the one or more memories. The one or more processors may individually or collectively be operable to execute the code to cause the UE to receive a first message indicating a first configuration associated with a random access procedure, the first configuration indicating a first set of random access occasions for transmission of a preamble message, determine a second set of random access occasions for the transmission of the preamble message, the second set of random access occasions offset relative to the first set of random access occasions in accordance with a second configuration that is based on the first set of random access occasions, and transmit the preamble message via at least one random access occasion of the second set of random access occasions.

Another UE for wireless communications is described. The UE may include means for receiving a first message indicating a first configuration associated with a random access procedure, the first configuration indicating a first set of random access occasions for transmission of a preamble message, means for determining a second set of random access occasions for the transmission of the preamble message, the second set of random access occasions offset relative to the first set of random access occasions in accordance with a second configuration that is based on the first set of random access occasions, and means for transmitting the preamble message via at least one random access occasion of the second set of random access occasions.

A non-transitory computer-readable medium storing code for wireless communications is described. The code may include instructions executable by one or more processors to receive a first message indicating a first configuration associated with a random access procedure, the first configuration indicating a first set of random access occasions for transmission of a preamble message, determine a second set of random access occasions for the transmission of the preamble message, the second set of random access occasions offset relative to the first set of random access occasions in accordance with a second configuration that is based on the first set of random access occasions, and transmit the preamble message via at least one random access occasion of the second set of random access occasions.

Some examples of the method, UEs, and non-transitory computer-readable medium described herein may further include operations, features, means, or instructions for receiving a second message indicating the second configuration, the second configuration including a time offset, a frequency offset, or both, where determining the second set of random access occasions may be based on applying the time offset, the frequency offset, or both, to one or more random access occasions of the first set of random access occasions.

Some examples of the method, UEs, and non-transitory computer-readable medium described herein may further include operations, features, means, or instructions for applying the time offset, the frequency offset, or both, to a first random access occasion of the first set of random access occasions to identify a second random access occasion of the second set of random access occasions and determine a set of one or more additional random access occasions of the second set of random access occasions based on the second random access occasion.

In some examples of the method, UEs, and non-transitory computer-readable medium described herein, the set of one or more additional random access occasions may be adjacent in time, frequency, or both, to the second random access occasion.

Some examples of the method, UEs, and non-transitory computer-readable medium described herein may further include operations, features, means, or instructions for applying a second time offset, a second frequency offset, or both, to the second random access occasion in accordance with the second configuration to identify the set of one or more additional random access occasions.

In some examples of the method, UEs, and non-transitory computer-readable medium described herein, the second random access occasion, or the set of one or more additional random access occasions, or both, may be mapped to a same synchronization signal block as the first random access occasion.

In some examples of the method, UEs, and non-transitory computer-readable medium described herein, the second random access occasion, or the set of one or more additional random access occasions, or both, may be mapped to respective synchronization signal blocks.

In some examples of the method, UEs, and non-transitory computer-readable medium described herein, the first set of random access occasions and the second set of random access occasions may be jointly mapped to a set of synchronization signal blocks.

In some examples of the method, UEs, and non-transitory computer-readable medium described herein, each random access occasion of the second set of random access occasions may be offset from one or more random access occasion of the first set of random access occasions.

In some examples of the method, UEs, and non-transitory computer-readable medium described herein, one or more valid random access occasions of the second set of random access occasions may be non-overlapping with respective random access occasions of the first set of random access occasions.

Some examples of the method, UEs, and non-transitory computer-readable medium described herein may further include operations, features, means, or instructions for identifying one or more valid random access occasions of the first set of random access occasions, where the second set of random access occasions may be offset from the one or more valid random access occasions of the first set of random access occasions.

In some examples of the method, UEs, and non-transitory computer-readable medium described herein, each random access occasion of the first set of random access occasions may be mapped to a synchronization signal block of a set of synchronization signal blocks and the method, apparatuses, and non-transitory computer-readable medium may include further operations, features, means, or instructions for identifying the second set of random access occasions based on a subset of the first set of random access occasions, where second set of random access occasions may be offset relative to the subset based on the subset being mapped to a first synchronization signal block of the set of synchronization signal blocks.

In some examples of the method, UEs, and non-transitory computer-readable medium described herein, each random access occasion of the first set of random access occasions may be mapped to a synchronization signal block of a set of synchronization signal blocks and the method, apparatuses, and non-transitory computer-readable medium may include further operations, features, means, or instructions for identifying one or more random access occasions of the second set of random access occasions based at least in part on an index of a first synchronization signal block that may be mapped to a first random access occasion of the first set of random access occasions, where the one or more random access occasions may be each mapped to the index of the first synchronization signal block.

Some examples of the method, UEs, and non-transitory computer-readable medium described herein may further include operations, features, means, or instructions for receiving a control message indicating whether the second set of random access occasions may be activated, where determining the second set of random access occasions may be based on receiving the control message.

In some examples of the method, UEs, and non-transitory computer-readable medium described herein, the control message indicates the second configuration, a set of beams associated with the second set of random access occasions, a quantity of random access occasions for the second set of random access occasions, or any combination thereof.

In some examples of the method, UEs, and non-transitory computer-readable medium described herein, the first set of random access occasions may be associated with a first set of preambles for transmission of the preamble message, and the second set of random access occasions may be associated with a second set of preambles different from the first set of preambles.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports offsets for random access channel configurations in accordance with one or more aspects of the present disclosure.

FIG. 2 shows an example of a network architecture that supports offset random access channel configurations for time and spatial adaptation in accordance with one or more aspects of the present disclosure.

FIG. 3 shows an example of a wireless communications system that supports offsets for random access channel configurations in accordance with one or more aspects of the present disclosure.

FIGS. 4A, 4B, 5, 6A, and 6B show examples of random access resource diagrams that support offsets for random access channel configurations in accordance with one or more aspects of the present disclosure.

FIGS. 7 and 8 show block diagrams of devices that support offsets for random access channel configurations in accordance with one or more aspects of the present disclosure.

FIG. 9 shows a block diagram of a communications manager that supports offsets for random access channel configurations in accordance with one or more aspects of the present disclosure.

FIG. 10 shows a diagram of a system including a device that supports offsets for random access channel configurations in accordance with one or more aspects of the present disclosure.

FIGS. 11 and 12 shows flowcharts illustrating methods that support offsets for random access channel configurations in accordance with one or more aspects of the present disclosure.

### DETAILED DESCRIPTION

In some systems, random access procedures may be used by a user equipment (UE) to initiate access to a network. For example, the UE may determine a set of random access occasions based on one or more signals received from a network entity, and the UE may transmit a preamble message via a random access occasion of the set of random access occasions to initiate communications with the network entity. In some cases, however, the set of random access occasions may be limited, and expanding the availability of random access occasions and/or making random access occasions relatively more flexible, may be difficult without impacting other UEs that may not support new configurations.

In accordance with examples as described herein, a UE may receive one or more random access configurations indicating a first set of random access occasions from a network entity, and the UE may determine a second set of random access occasions based on the first set of random access occasions. For example, the UE may apply one or more configurations (e.g., rules, functions, offsets) to the first set of random access occasions to obtain the second set of random access occasions. In some examples, applying the configuration may include applying a time offset, a frequency offset, or both, to one or more occasions of the first set of random access occasions. As such, the UE may perform random access operations with the network entity using preamble message transmission via a derived random access occasion, thereby expanding the availability of transmission occasions without impacting other UEs that may not support the additional random access occasions.

Aspects of the disclosure are initially described in the context of wireless communications systems. Aspects of the disclosure are additionally described in the context of random access resource diagrams. Aspects of the disclosure are further illustrated by and described with reference to apparatus diagrams, system diagrams, and flowcharts that relate to offsets for random access channel configurations.

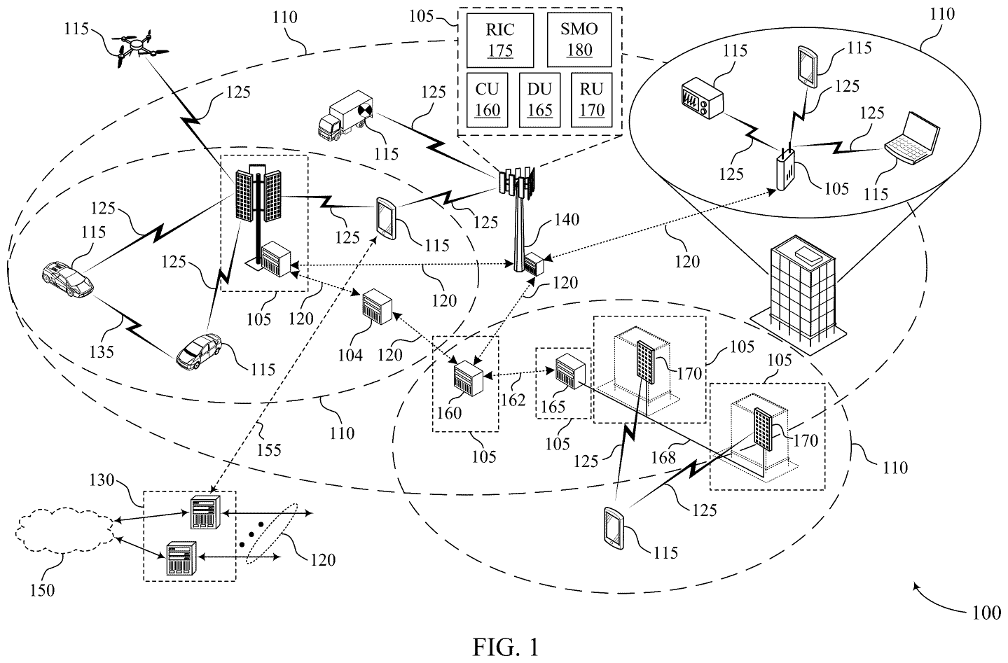

FIG. 1 shows an example of a wireless communications system 100 that supports offsets for random access channel configurations in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, to initiate communications with a network entity 105 (e.g., a network), a UE 115 may perform a random access procedures. For example, the UE 115 decodes system information, the UE 115 may transmit a preamble (e.g., a random access channel (RACH) preamble) to a network entity 105. For example, the preamble (e.g., for inclusion in a preamble message) may be randomly selected from a set of 64 predetermined sequences. This may enable the network entity 105 to distinguish between multiple UEs 115 trying to access the system simultaneously. The network entity 105 may respond with a random access response that provides an uplink resource grant, a timing advance, and a temporary cell-radio network temporary identity (C-RNTI). The UE 115 may then transmit an RRC connection request along with a temporary mobile subscriber identity (TMSI) (e.g., if the UE 115 has previously been connected to the same wireless network) or a random identifier. The RRC connection request may also indicate the reason the UE 115 is connecting to the network (e.g., emergency, signaling, data exchange, or the like). The network entity 105 may respond to the connection request with a contention resolution message addressed to the UE 115, which may provide a new C-RNTI. If the UE 115 receives a contention resolution message with the correct identification, it may proceed with RRC setup. If the UE 115 does not receive a contention resolution message (e.g., if there is a conflict with another UE 115) it may repeat the RACH process by transmitting a new RACH preamble. In some aspects, a UE 115 may perform four-step random access procedures, two-step random access procedures, or both. The UE 115 may determine a set of random access occasions based on a signal (e.g., one or more random access configurations) received from a network entity 105, and the UE may transmit a preamble message via a random access occasion of the set of random access occasions to initiate communications with the network entity 105. In some cases, however, the set of random access occasions may be limited, which may introduce latencies to initiating communications. Additionally, in some cases, expanding the availability of random access occasions may be difficult without impacting UEs 115 that may not support additional configurations or occasions.

In accordance with examples as described herein, a UE 115 may receive one or more random access configurations indicating a first set of random access occasions from a network entity 105, and the UE 115 may derive a second set of random based on the first set of random access occasions. For example, the UE 115 may apply one or more configurations to the first set of random access occasions to obtain the second set of random access occasions. In some examples, applying the configuration may include applying a time offset, a frequency offset, or both, to one or more occasions of the first set of random access occasions, thereby achieving one or more additional occasions that are shifted in time, frequency, or both. As such, the UE 115 may transmit a preamble message for a random access procedure via a derived random access occasion, thereby expanding the availability of transmission occasions without impacting other UEs 115 that may not support configurations having additional random access occasions.

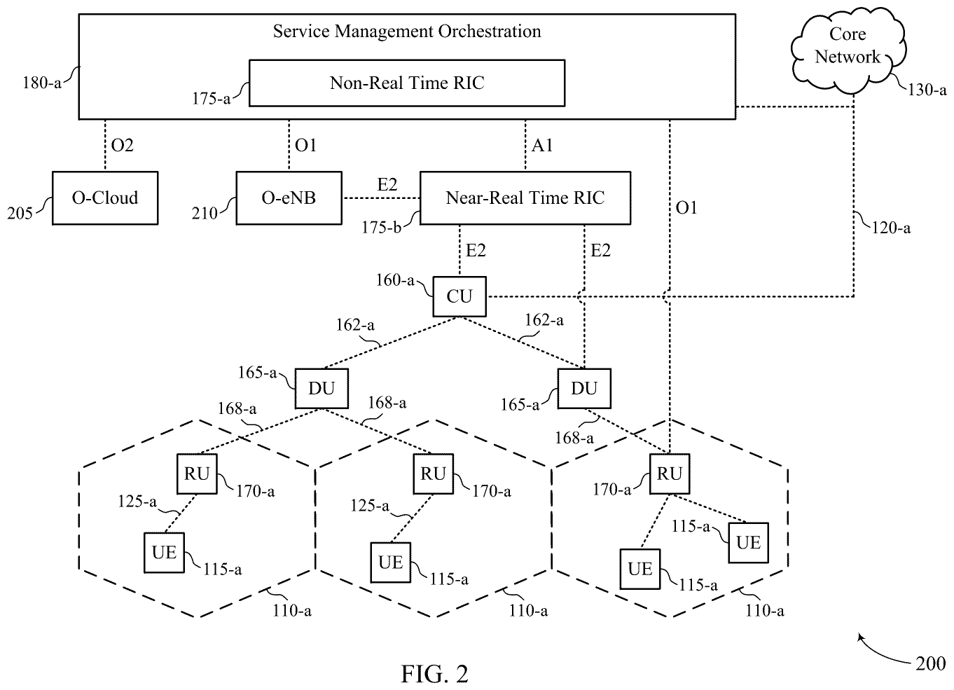

FIG. 2 shows an example of a network architecture 200 (e.g., a disaggregated base station architecture, a disaggregated RAN architecture) that supports offset random access channel configurations for time and spatial adaptation in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In accordance with examples as described herein, a UE 115-a may receive one or more random access configurations indicating a first set of random access occasions, for example, from an RU 170-a, a DU 165-a, a CU 160-a, or another device described in the network architecture 200. The UE 115-a may derive a second set of random based on the first set of random access occasions. For example, the UE 115-a may apply one or more configurations to the first set of random access occasions to obtain the second set of random access occasions. In some examples, applying the configuration may include applying a time offset, a frequency offset, or both, to one or more occasions of the first set of random access occasions, thereby achieving one or more additional occasions that are shifted in time, frequency, or both. As such, the UE 115-a may transmit a preamble message for a random access procedure via a derived random access occasion, thereby expanding the availability of transmission occasions without impacting other UEs 115-a that may not support configurations having additional random access occasions.

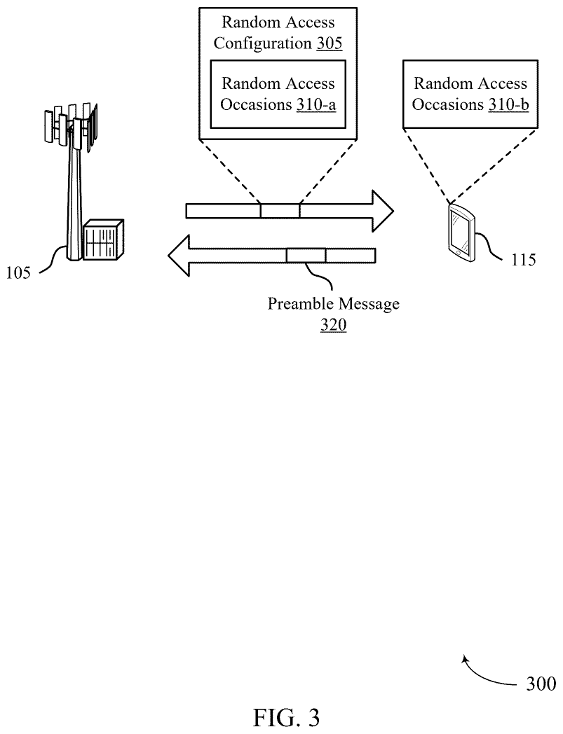

FIG. 3 shows an example of a wireless communications system 300 that supports offsets for random access channel configurations in accordance with one or more aspects of the present disclosure. The wireless communications system 300 illustrates communications between a UE 115 and a network entity 105, which may be examples of corresponding devices as described herein.

In some examples, to initiate communications with the network entity 105, the UE 115 may perform a random access procedure. For example, the UE 115 may transmit, as part of the random access procedure, a preamble message 320. The preamble message 320 may be associated with a mapping between a preamble occasion and a payload occasion for transmission of a payload message (e.g., as part of the random access procedure). For example, the network entity 105 may associate a payload message received during a payload occasion with the UE 115 based on receiving a preamble message 320 during a random access occasion (e.g., a preamble occasion) corresponding to the payload occasion.

Additionally, or alternatively, the UE 115 may select a preamble from a set of preambles to include in the preamble message 320, and the preamble may map to one or more payload occasions. As such, a preamble message 320 may allow the network entity 105 to identify a corresponding payload message received during a subsequent payload occasion. In some examples, each preamble may correspond to a payload occasion, a demodulation reference signal (DMRS) sequence, a port for transmission of the payload during the corresponding payload occasion, or a combination thereof. Additionally, or alternatively, each random access occasion corresponding to a preamble may be associated with a beam direction, and each corresponding payload occasion may be associated with the same beam direction, facilitating transmission by the UE 115 and reception by the network entity 105.

In some examples, the network entity 105 may transmit one or more messages indicating a random access configuration 305. In some examples, the random access configuration 305 may indicate a set of random access occasions 310-a. For example, the set of random access occasions 310-a may include one or more occasions for transmission of a preamble message 320 by the UE 115. In some cases, however, the set of random access occasions may be limited, which may limit opportunities for the UE 115 to initiate communications with the network entity 105 and may thereby introduce latencies to initiating communications. Additionally, in some cases, expanding the availability and/or the flexibility of random access occasions may be difficult without impacting other UEs 115 that may not support additional configurations or occasions.

In accordance with examples as described herein, the UE 115 may determine a set of random access occasions 310-b for communication of a preamble message to the network entity 105. For example, the UE 115 may apply a second configuration to the set of random access occasions 310-a to obtain the set of random access occasions 310-b. In some examples, the second configuration may be received from a message (e.g., a separate message or the same message including the random access configuration 305) from the network entity 105. Additionally, or alternatively, the second configuration may be configured to the UE 115 via another network entity (e.g., a previously connected network), or during initial configuration of the UE 115. Accordingly, the UE 115 may derive additional random access occasions for transmission of a preamble message using a simple configuration which may avoid impacting other UEs 115 that may not support the second configuration or additional random access occasions.

In some examples, to determine the set of random access occasions 310-b (e.g., in accordance with the second configuration), the UE 115 may apply a time offset, a frequency offset, or both, to at least a subset of the set of random access occasions 310-a. For example, the UE 115 may apply the second configuration to all occasions of the set of random access occasions 310-a, or to valid occasions of the set of random access occasions 310-a. Additionally, or alternatively, the UE 115 may apply the second configuration (e.g., one or more offsets) to at least some occasions of the set of random access occasions 310-a to obtain a first subset of the set of random access occasions 310-b, and the UE 115 may obtain a second subset of the set of random access occasions 310-b based on the first subset (e.g., consecutively in time, frequency, or with some gap in time or frequency).

In some examples, the set of random access occasions 310-b may be determined by the UE 115 based on a synchronization signal block (SSB) associated with a respective occasion. For example, the network entity 105 may transmit (e.g., broadcast) one or more SSBs having corresponding indexes, and each SSB may include one or more sets of random access occasions 310 (e.g., via one or more random access configurations 305). The UE 115 may apply the second configuration to occasions associated with a specific SSB (e.g., with a first SSB index), or may apply different configurations to occasions associated with different SSBs (e.g., based on the associated SSB index).

In some cases, the UE 115 may be configured to use (e.g., activate) or derive the set of random access occasions 310-b based on one or more conditions. For example, the UE 115 may receive a message (e.g., an activation message) from the network entity 105 indicating that the UE 115 enable (e.g., activate) the use or the derivation of the set of random access occasions 310-b. In some examples, the message may additionally indicate a time offset, a frequency offset, or both, for deriving the set of random access occasions 310-b. In some cases, the message may indicate a set of one or more beams for the set of random access occasions 310-b, a quantity of occasions to be derived from each occasions of the set of random access occasions 310-a, or both. Additionally, or alternatively, the UE 115 may use or derive the set of random access occasions 310-b based on a random access procedure (e.g., via an occasion of the set of random access occasions 310-a) being unsuccessful, for example, due to contention or interference, or based on a latency associated with a random access procedure exceeding a threshold value.

In some examples, the UE 115 may use a same configuration for each occasion of the set of random access occasions 310-b as a configuration for a corresponding occasion of the set of random access occasions 310-a. For example, a first occasion of the set of random access occasions 310-b may be associated with a set of preambles for a preamble message 320 transmission that is the same as a second of the occasion set of random access occasions 310-a from which the first occasion was derived. Alternatively, each of the occasions of the set of random access occasions 310-a may be associated with a first set of preambles, and each of the occasions of the set of random access occasions 310-b may be associated with a second set of preambles different from the first set. As such, the network entity 105 may determine that the UE 115 is transmitting a preamble message 320 using a derived occasion (e.g., an occasion of the set of random access occasions 310-b) based on receiving a preamble message 320 having a preamble from the second set of preambles.

Accordingly, the UE 115 may derive an additional set of random access occasions 310-b, which may increase the availability of opportunities for transmission of the preamble message 320 and thereby support the initiation of communications between the UE 115 and the network entity 105 with reduced latency, interference, or both.

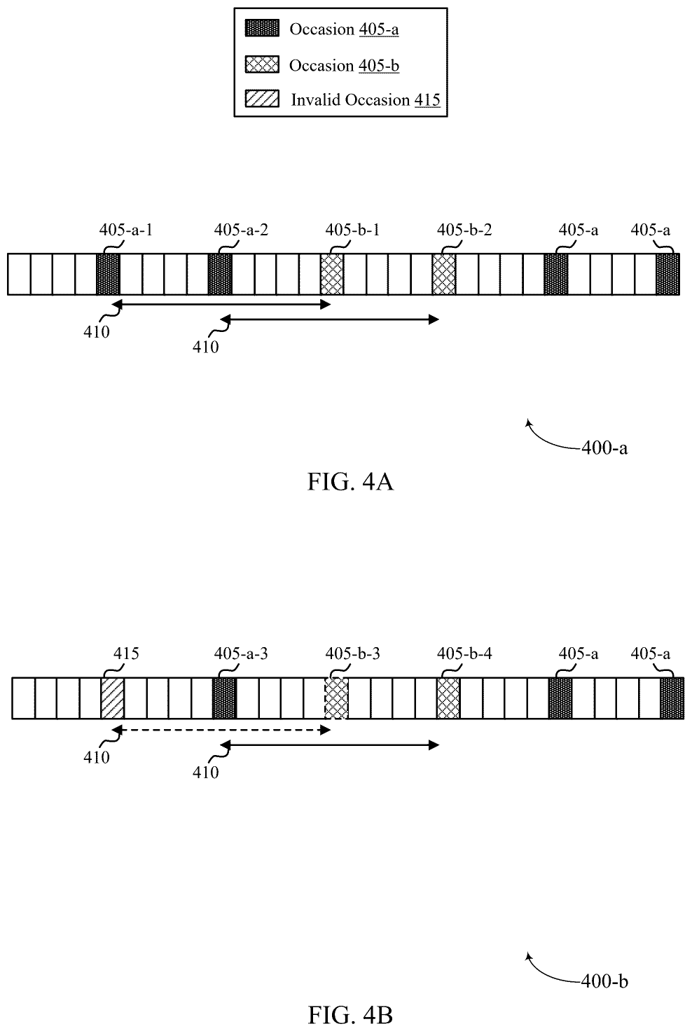

FIG. 4A and FIG. 4B show examples of a random access resource diagram 400-a and a random access resource diagram 400-b that support offsets for random access channel configurations in accordance with one or more aspects of the present disclosure. For example, the random access resource diagram 400-a and the random access resource diagram 400-b illustrate examples of occasions 405-a (e.g., random access occasions), which may be configured to a UE 115 based on a random access configuration (e.g., via an SSB), and occasions 405-b (e.g., random access occasions, derived random access occasions) that may be determined from the occasions 405-a, as described herein.

In some examples, the UE 115 may determine the occasions 405-b based on a configuration (e.g., a RACH configuration), which may be indicated to the UE 115 by a network entity 105. In some cases, the configuration may include a time offset, a frequency offset, or both. For example, the UE 115 may apply an offset 410 with respect to an occasion 405-a-1 to determine the occasion 405-b-1, and the UE 115 may apply the offset 410 with respect to the occasion 405-a-2 to determine the occasion 405-b-2. In some examples, applying the offset 410 to the occasions 405-a may result in one or more occasions 405-b that are shifted in time (e.g., shifted in the time domain), as illustrated by the random access resource diagram 400-a. For example, the configuration may indicate a time offset as a quantity of slots (e.g., RACH slots), a quantity of subframes, a quantity of frames, or a combination thereof, used to shift the occasions 405-a to determine the occasions 405-b.

Additionally, or alternatively, applying the offset 410 may shift the occasions 405-b in frequency (e.g., shift in the frequency domain) relative to the occasions 405-a. For example, the configuration may indicate a frequency offset as a quantity of resource elements, a quantity of resource blocks, a quantity of resource block groups, or a combination thereof, which may be used to determine the occasions 405-b shifted in frequency from the occasions 405-a. In some aspects, the offset 410 may shift the occasions 405-b in both frequency and time (e.g., in both the time domain and the frequency domain).

In some examples, the UE 115 may be configured to apply the configuration (e.g., and the offset 410) to each occasion 405-a of a set of occasions 405-a configured to the UE 115 (e.g., via a random access configuration, via an SSB). In some other examples, the UE 115 may be configured to apply the configuration to a subset of the set of occasions 405-a configured to the UE 115. For example, one or more of the set of occasions 405-a may be invalid occasions 415, such as if an occasion overlaps with another configured resource (e.g., an uplink resource, a downlink resource, an SSB resource).

In some cases, the UE 115 may be configured to apply the configuration to one or more invalid occasions 415, and the UE 115 may determine an occasion 405-b-3 and an occasion 405-b-4 relative to the invalid occasion 415 and an occasion 405-a-3, respectively. Alternatively, the UE 115 may refrain from applying the configuration (e.g., the offset 410) to the invalid occasion 415, and may instead apply the configuration to valid occasions 405-a (e.g., the occasion 405-a-3).

In some examples, the occasions 405-b determined by the UE 115 may be determined to be valid based on a similar (e.g., or same) criteria as occasions 405-a. For example, if an occasion 405-b determined by the UE 115 based on applying the offset 410 overlaps with another configured resource (e.g., an uplink resource, a downlink resource, an SSB resource), the UE 115 may consider the determined occasion 405-b as invalid and refrain from transmitting a preamble message via the occasion 405-b. In some cases, the UE 115 may additionally, or alternatively, consider an occasion 405-b as invalid if the occasion 405-b overlaps with an occasion 405-a. As described herein, an occasion may be considered to overlap with another occasion by the UE 115 if the occasions partially overlap in time, fully overlap in time, partially overlap in frequency, fully overlap in frequency, or any combination thereof.

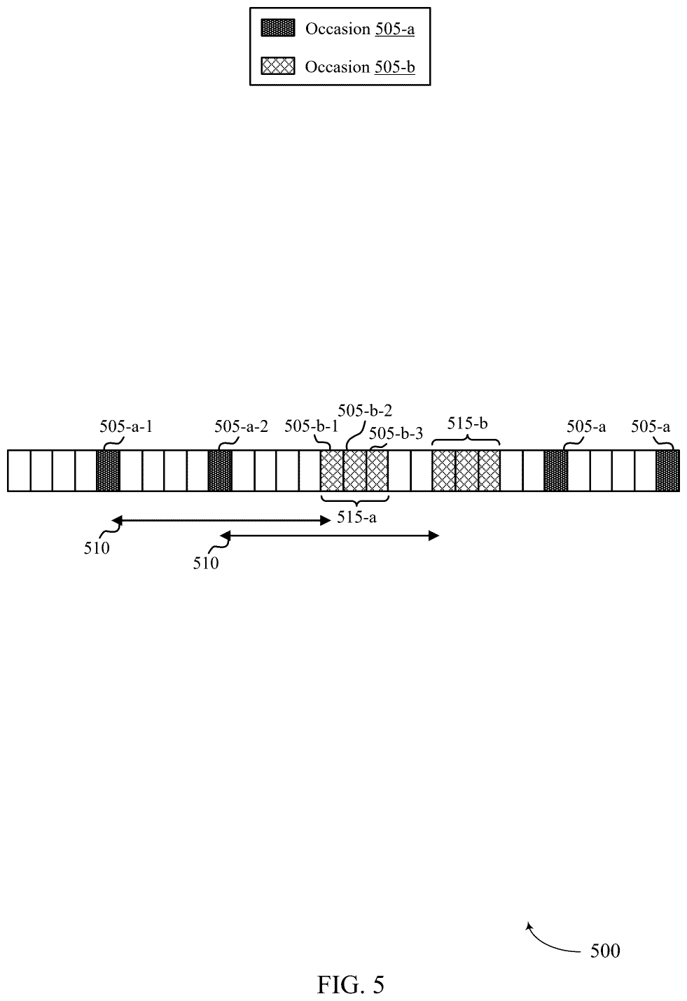

FIG. 5 shows an example of a random access resource diagram 500 that supports offsets for random access channel configurations in accordance with one or more aspects of the present disclosure. For example, the random access resource diagram 500 illustrates example occasions 505-a (e.g., random access occasions), which may be configured to a UE 115 based on a random access configuration (e.g., via an SSB), and occasions 505-b (e.g., random access occasions, derived random access occasions) that may be determined from the occasions 505-a, as described herein.

In some examples, the UE 115 may determine multiple occasions 505-b from an occasion 505-a. For example, the UE 115 may apply an offset 510 (e.g., based on a random access configuration, a time offset, a frequency offset) to an occasion 505-a-1 to obtain an occasion 505-b-1. The UE 115 may then determine one or more additional occasions 505-b from the occasion 505-b-1. For example, the UE 115 may apply a second configuration (e.g., a random access configuration) to the occasion 505-b-1 to obtain an occasion 505-b-2 and an occasion 505-b-3. In some examples, the UE 115 may determine the occasion 505-b-2 and the occasion 505-b-3 to be consecutive (e.g., adjacent) in time, frequency, or both, to the occasion 505-b-1 (e.g., and other derived occasions 505-b). Additionally, or alternatively, the UE 115 may determine the occasion 505-b-2 and to occasion 505-b-3 based on a gap (e.g., an offset, an additional offset) in time, frequency, or both, from a previous occasion 505-b.

As such, the UE 115 may determine a set of occasions 515-a from the occasion 505-a-1. In some examples, the UE 115 may similarly obtain a set of occasions 515-b form the occasion 505-a-2, and for one or more additional configured occasions 505-a. In some examples, a set of occasions 515 may be mapped to a same SSB (e.g., be associated with a same SSB index) as an occasion 505-a used to derive the set of occasions 515. Alternatively, derived sets of occasions 515 may be mapped to SSBs separately from occasions 505-a, or may be mapped to SSBs jointly with the occasions 505-b.

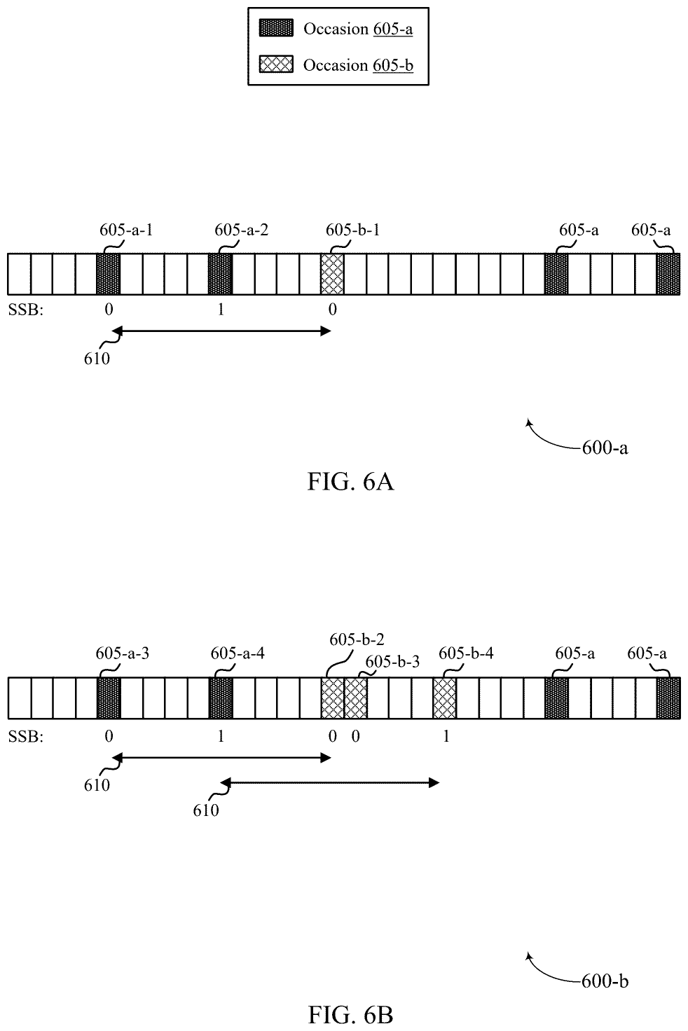

FIG. 6A and FIG. 6B show examples of a random access resource diagram 600-a and a random access resource diagram 600-b that support offsets for random access channel configurations in accordance with one or more aspects of the present disclosure. For example, the random access resource diagram 600-a and the random access resource diagram 600-b illustrate examples of occasions 605-a (e.g., random access occasions), which may be configured to a UE 115 based on a random access configuration (e.g., via an SSB), and occasions 605-b (e.g., random access occasions, derived random access occasions) that may be determined from the occasions 605-a, as described herein.

In some examples, the UE 115 may determine the occasions 605-b based on a configuration (e.g., a random access configuration). The UE 115 may additionally be configured to determine one or more occasions 605-b based on the one or more occasions 605-b by applying one or more additional configurations (e.g., random access configurations), which may involve the application of an offset 610, as described herein.

In some cases, the UE 115 may determine occasions 605-b from occasions 605-a based on an SSB associated with a respective occasion 605-a. For example, an occasion 605-a-1 may be mapped to (e.g., associated with) an SSB with an index value of zero (e.g., SSB0), and an occasion 605-a-2 may be mapped to an SSB with an index value of one (e.g., SSB1). In some examples, as illustrated by the random access resource diagram 600-a, the UE 115 may determine apply a configuration (e.g., an offset 610) to occasions 605-a mapped to one or more specific SSBs. For example, the UE 115 may apply the offset 610 to the occasion 605-a-1 associated with an SSB index of zero to obtain the occasion 605-b-1, and the UE 115 may refrain from applying any configuration to the occasion 605-a-2 to obtain an occasion 605-b.

In some examples, as illustrated by the random access resource diagram 600-b, the UE 115 may apply different configurations (e.g., functions, offsets), to occasions 605-a based on a corresponding SSB. For example, the UE 115 may apply a function (e.g., f(i)) to an occasion 605-a, where the function is based on a value of the corresponding SSB index (e.g., i). In some examples, the UE 115 may apply a first configuration (e.g., a function f(0)) to an occasion 605-a-3 based on a corresponding SSB index (e.g., 0) to obtain one or more occasions 605-b. For instance, the UE 115 may apply the offset 610 to the occasion 605-a-3 to obtain an occasion 605-b-2, and the UE 115 may then determine an occasion 605-b-3 consecutive to the occasion 605-b-2 (e.g., as described with reference to FIG. 4). The UE 115 may then apply a second configuration (e.g., a function f(1)) to an occasion 605-a-4 based on a corresponding SSB index (e.g., 1) to obtain one or more occasions 605-b. For instance, the UE 115 may apply the offset to the occasion 605-a-4 to obtain an occasion 605-b-4.

In some cases, a derived occasion 605-b may be mapped to a same SSB as a corresponding occasion 605-a. For example, the occasion 605-b-1 may be mapped to an SSB with index zero (e.g., SSB0) based on the occasion 605-a-1 being mapped to the SSB with index zero, as illustrated by the random access resource diagram 600-a. Similarly, the occasion 605-b-2 and the occasion 605-b-3 may each be mapped to the SSB with index zero based on the occasion 605-a-3 being mapped to the SSB with index zero, and the occasion 605-b-4 may be mapped to an SSB with index one (e.g., SSB1) based on the occasion 605-a-3 being mapped to the SSB with index one.

Accordingly, the UE 115 may derive additional occasions 605-b from occasions 605-a, which may increase the availability of opportunities for transmission of preamble messages and thereby support the initiation of communications between the UE 115 and a network entity 105 with reduced latency, interference, or both.

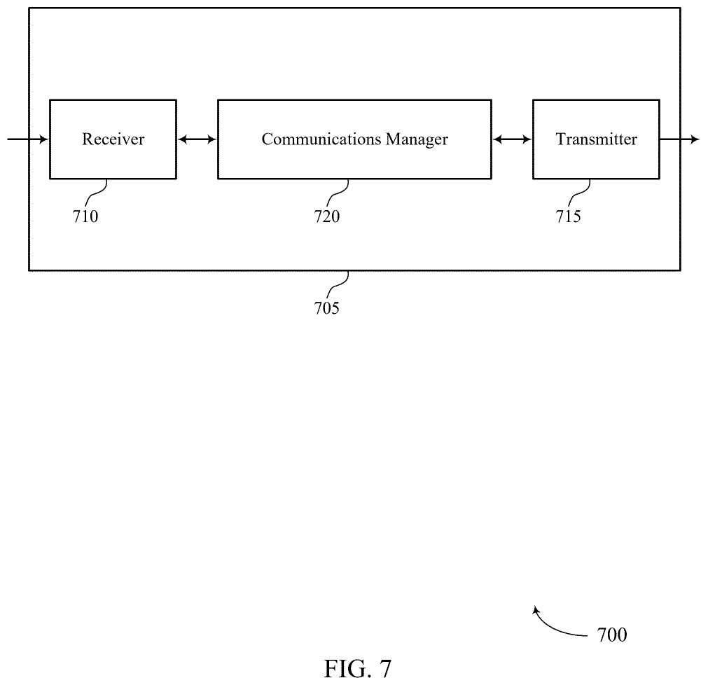

FIG. 7 shows a block diagram 700 of a device 705 that supports offsets for random access channel configurations in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to offsets for random access channel configurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to offsets for random access channel configurations). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of offsets for random access channel configurations as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving a first message indicating a first configuration associated with a random access procedure, the first configuration indicating a first set of random access occasions for transmission of a preamble message. The communications manager 720 is capable of, configured to, or operable to support a means for determining a second set of random access occasions for the transmission of the preamble message, the second set of random access occasions offset relative to the first set of random access occasions in accordance with a second configuration that is based on the first set of random access occasions. The communications manager 720 is capable of, configured to, or operable to support a means for transmitting the preamble message via at least one random access occasion of the second set of random access occasions.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for deriving random access occasions to support a larger quantity of random access occasions, which may improve spatial domain or time domain resource utilization, reducing latency associated with random access procedures, and may avoid impacting devices that may not support configurations including additional random access occasions.

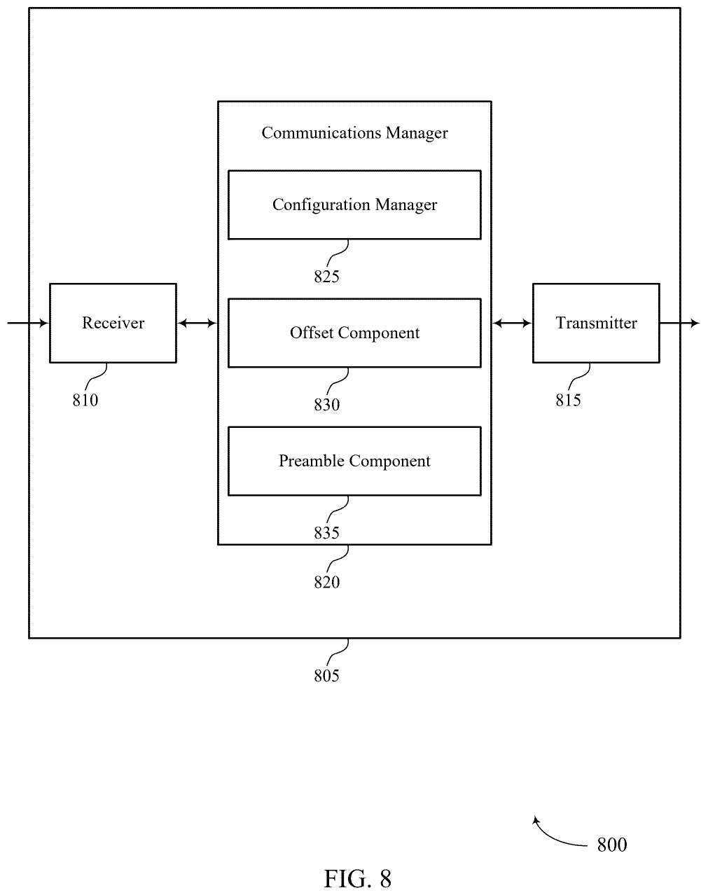

FIG. 8 shows a block diagram 800 of a device 805 that supports offsets for random access channel configurations in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to offsets for random access channel configurations). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to offsets for random access channel configurations). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of offsets for random access channel configurations as described herein. For example, the communications manager 820 may include a configuration manager 825, an offset component 830, a preamble component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The configuration manager 825 is capable of, configured to, or operable to support a means for receiving a first message indicating a first configuration associated with a random access procedure, the first configuration indicating a first set of random access occasions for transmission of a preamble message. The offset component 830 is capable of, configured to, or operable to support a means for determining a second set of random access occasions for the transmission of the preamble message, the second set of random access occasions offset relative to the first set of random access occasions in accordance with a second configuration that is based on the first set of random access occasions. The preamble component 835 is capable of, configured to, or operable to support a means for transmitting the preamble message via at least one random access occasion of the second set of random access occasions.

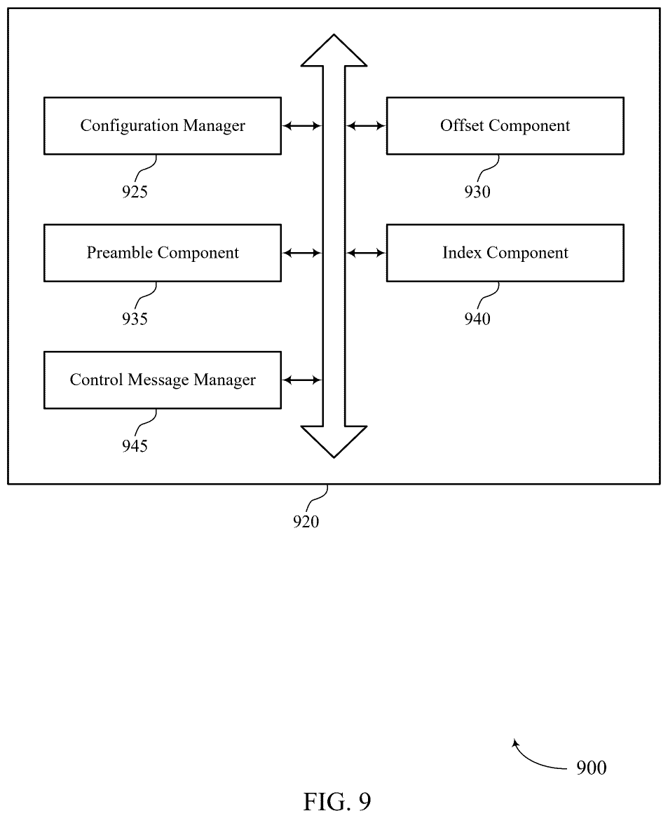

FIG. 9 shows a block diagram 900 of a communications manager 920 that supports offsets for random access channel configurations in accordance with one or more aspects of the present disclosure. The communications manager 920 may be an example of aspects of a communications manager 720, a communications manager 820, or both, as described herein. The communications manager 920, or various components thereof, may be an example of means for performing various aspects of offsets for random access channel configurations as described herein. For example, the communications manager 920 may include a configuration manager 925, an offset component 930, a preamble component 935, an index component 940, a control message manager 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The configuration manager 925 is capable of, configured to, or operable to support a means for receiving a first message indicating a first configuration associated with a random access procedure, the first configuration indicating a first set of random access occasions for transmission of a preamble message. The offset component 930 is capable of, configured to, or operable to support a means for determining a second set of random access occasions for the transmission of the preamble message, the second set of random access occasions offset relative to the first set of random access occasions in accordance with a second configuration that is based on the first set of random access occasions. The preamble component 935 is capable of, configured to, or operable to support a means for transmitting the preamble message via at least one random access occasion of the second set of random access occasions.

In some examples, the configuration manager 925 is capable of, configured to, or operable to support a means for receiving a second message indicating the second configuration, the second configuration including a time offset, a frequency offset, or both, where determining the second set of random access occasions is based on applying the time offset, the frequency offset, or both, to one or more random access occasions of the first set of random access occasions.

In some examples, the offset component 930 is capable of, configured to, or operable to support a means for applying the time offset, the frequency offset, or both, to a first random access occasion of the first set of random access occasions to identify a second random access occasion of the second set of random access occasions. In some examples, the offset component 930 is capable of, configured to, or operable to support a means for determine a set of one or more additional random access occasions of the second set of random access occasions based on the second random access occasion. In some examples, the set of one or more additional random access occasions is adjacent in time, frequency, or both, to the second random access occasion.

In some examples, the offset component 930 is capable of, configured to, or operable to support a means for applying a second time offset, a second frequency offset, or both, to the second random access occasion in accordance with the second configuration to identify the set of one or more additional random access occasions.

In some examples, the second random access occasion, or the set of one or more additional random access occasions, or both, are mapped to a same synchronization signal block as the first random access occasion.

In some examples, the second random access occasion, or the set of one or more additional random access occasions, or both, are mapped to respective synchronization signal blocks. In some examples, the first set of random access occasions and the second set of random access occasions are jointly mapped to a set of synchronization signal blocks.

In some examples, each random access occasion of the second set of random access occasions is offset from one or more random access occasion of the first set of random access occasions. In some examples, one or more valid random access occasions of the second set of random access occasions are non-overlapping with respective random access occasions of the first set of random access occasions.

In some examples, the offset component 930 is capable of, configured to, or operable to support a means for identifying one or more valid random access occasions of the first set of random access occasions, where the second set of random access occasions are offset from the one or more valid random access occasions of the first set of random access occasions.

In some examples, each random access occasion of the first set of random access occasions is mapped to a synchronization signal block of a set of synchronization signal blocks, and the offset component 930 is capable of, configured to, or operable to support a means for identifying the second set of random access occasions based on a subset of the first set of random access occasions, where second set of random access occasions are offset relative to the subset based on the subset being mapped to a first synchronization signal block of the set of synchronization signal blocks.

In some examples, each random access occasion of the first set of random access occasions is mapped to a synchronization signal block of a set of synchronization signal blocks, and the index component 940 is capable of, configured to, or operable to support a means for identifying one or more random access occasions of the second set of random access occasions based at least in part on an index of a first synchronization signal block that is mapped to a first random access occasion of the first set of random access occasions, where the one or more random access occasions are each mapped to the index of the first synchronization signal block.

In some examples, the control message manager 945 is capable of, configured to, or operable to support a means for receiving a control message indicating whether the second set of random access occasions are activated, where determining the second set of random access occasions is based on receiving the control message.

In some examples, the control message indicates the second configuration, a set of beams associated with the second set of random access occasions, a quantity of random access occasions for the second set of random access occasions, or any combination thereof.

In some examples, the first set of random access occasions is associated with a first set of preambles for transmission of the preamble message, and the second set of random access occasions is associated with a second set of preambles different from the first set of preambles.

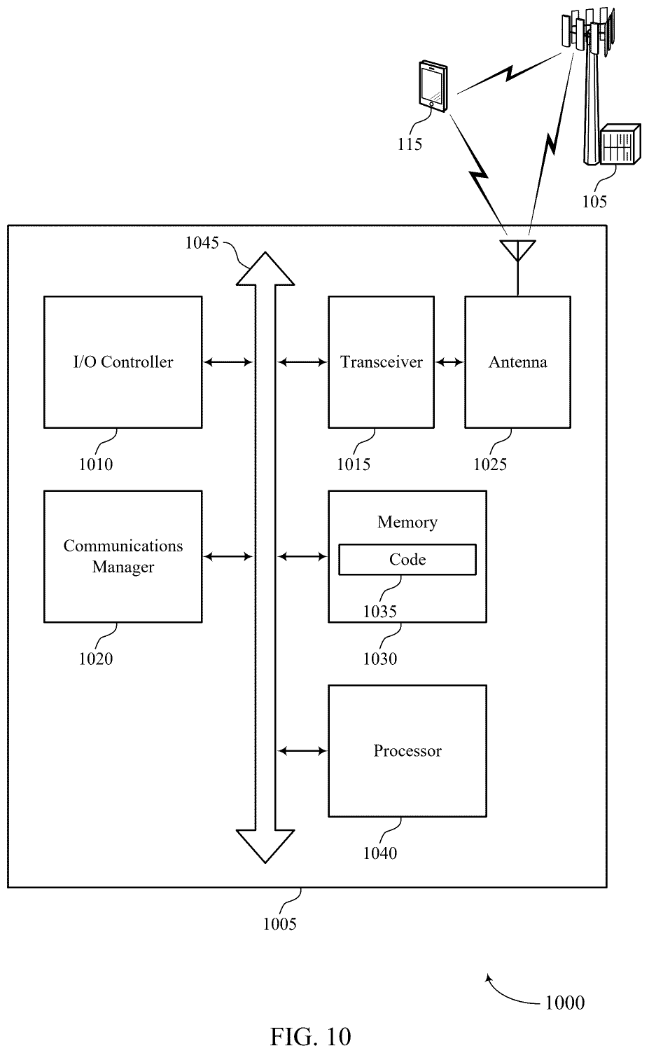

FIG. 10 shows a diagram of a system 1000 including a device 1005 that supports offsets for random access channel configurations in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting offsets for random access channel configurations). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving a first message indicating a first configuration associated with a random access procedure, the first configuration indicating a first set of random access occasions for transmission of a preamble message. The communications manager 1020 is capable of, configured to, or operable to support a means for determining a second set of random access occasions for the transmission of the preamble message, the second set of random access occasions offset relative to the first set of random access occasions in accordance with a second configuration that is based on the first set of random access occasions. The communications manager 1020 is capable of, configured to, or operable to support a means for transmitting the preamble message via at least one random access occasion of the second set of random access occasions.

By including or configuring the communications manager 1020 in accordance with examples as described herein, the device 1005 may support techniques for deriving random access occasions to support a larger quantity of random access occasions, which may improve spatial domain or time domain resource utilization, reducing latency associated with random access procedures, and may avoid impacting devices that may not support configurations including additional random access occasions.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of offsets for random access channel configurations as described herein, or the at least one processor 1040 and the at least one memory 1030 may be otherwise configured to, individually or collectively, perform or support such operations.

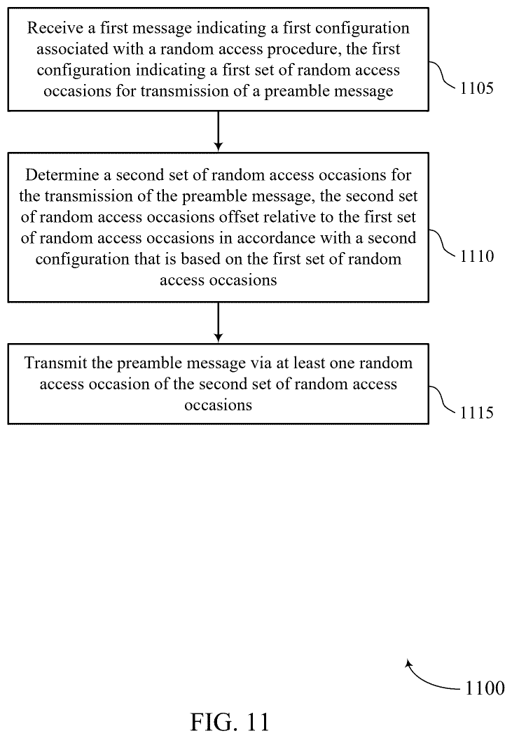

FIG. 11 shows a flowchart illustrating a method 1100 that supports offsets for random access channel configurations in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving a first message indicating a first configuration associated with a random access procedure, the first configuration indicating a first set of random access occasions for transmission of a preamble message. The operations of 1105 may be performed in accordance with examples as disclosed herein. In some examples, aspects of the operations of 1105 may be performed by a configuration manager 925 as described with reference to FIG. 9.

At 1110, the method may include determining a second set of random access occasions for the transmission of the preamble message, the second set of random access occasions offset relative to the first set of random access occasions in accordance with a second configuration that is based on the first set of random access occasions. The operations of 1110 may be performed in accordance with examples as disclosed herein. In some examples, aspects of the operations of 1110 may be performed by an offset component 930 as described with reference to FIG. 9.

At 1115, the method may include transmitting the preamble message via at least one random access occasion of the second set of random access occasions. The operations of 1115 may be performed in accordance with examples as disclosed herein. In some examples, aspects of the operations of 1115 may be performed by a preamble component 935 as described with reference to FIG. 9.

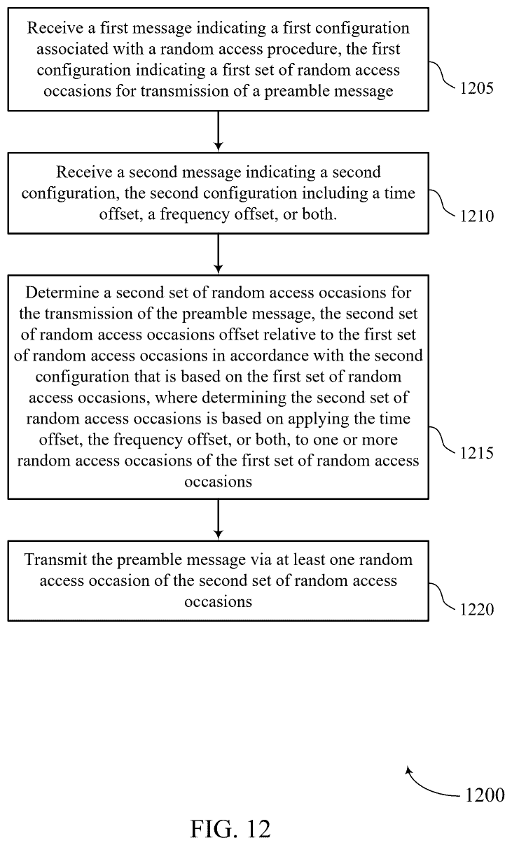

FIG. 12 shows a flowchart illustrating a method 1200 that supports offset random access channel configurations for time and spatial adaptation in accordance with one or more aspects of the present disclosure. The operations of the method 1200 may be implemented by a UE or its components as described herein. For example, the operations of the method 1200 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1205, the method may include receiving a first message indicating a first configuration associated with a random access procedure, the first configuration indicating a first set of random access occasions for transmission of a preamble message. The operations of 1205 may be performed in accordance with examples as disclosed herein. In some examples, aspects of the operations of 1205 may be performed by a configuration manager 825 as described with reference to FIG. 8.

At 1210, the method may include receiving a second message indicating a second configuration, the second configuration including a time offset, a frequency offset, or both. The operations of 1210 may be performed in accordance with examples as disclosed herein. In some examples, aspects of the operations of 1210 may be performed by a configuration manager 825 as described with reference to FIG. 8.

At 1215, the method may include determining a second set of random access occasions for the transmission of the preamble message, the second set of random access occasions offset relative to the first set of random access occasions in accordance with the second configuration that is based on the first set of random access occasions, where determining the second set of random access occasions is based on applying the time offset, the frequency offset, or both, to one or more random access occasions of the first set of random access occasions. The operations of 1215 may be performed in accordance with examples as disclosed herein. In some examples, aspects of the operations of 1215 may be performed by an offset component 830 as described with reference to FIG. 8.

At 1220, the method may include transmitting the preamble message via at least one random access occasion of the second set of random access occasions. The operations of 1220 may be performed in accordance with examples as disclosed herein. In some examples, aspects of the operations of 1220 may be performed by a preamble component 835 as described with reference to FIG. 8.

The following provides an overview of aspects of the present disclosure:
Aspect 1: A method for wireless communications by a UE, comprising: receiving a first message indicating a first configuration associated with a random access procedure, the first configuration indicating a first set of random access occasions for transmission of a preamble message; determining a second set of random access occasions for the transmission of the preamble message, the second set of random access occasions offset relative to the first set of random access occasions in accordance with a second configuration that is based at least in part on the first set of random access occasions; and transmitting the preamble message via at least one random access occasion of the second set of random access occasions.
Aspect 2: The method of aspect 1, further comprising: receiving a second message indicating the second configuration, the second configuration comprising a time offset, a frequency offset, or both, wherein determining the second set of random access occasions is based at least in part on applying the time offset, the frequency offset, or both, to one or more random access occasions of the first set of random access occasions.
Aspect 3: The method of aspect 2, further comprising: applying the time offset, the frequency offset, or both, to a first random access occasion of the first set of random access occasions to identify a second random access occasion of the second set of random access occasions; and determine a set of one or more additional random access occasions of the second set of random access occasions based at least in part on the second random access occasion.
Aspect 4: The method of aspect 3, wherein the set of one or more additional random access occasions is adjacent in time, frequency, or both, to the second random access occasion.
Aspect 5: The method of any of aspects 3 through 4, further comprising: applying a second time offset, a second frequency offset, or both, to the second random access occasion in accordance with the second configuration to identify the set of one or more additional random access occasions.
Aspect 6: The method of any of aspects 3 through 5, wherein the second random access occasion, or the set of one or more additional random access occasions, or both, are mapped to a same synchronization signal block as the first random access occasion.
Aspect 7: The method of any of aspects 3 through 6, wherein the second random access occasion, or the set of one or more additional random access occasions, or both, are mapped to respective synchronization signal blocks.
Aspect 8: The method of any of aspects 3 through 7, wherein the first set of random access occasions and the second set of random access occasions are jointly mapped to a set of synchronization signal blocks.
Aspect 9: The method of any of aspects 1 through 8, wherein each random access occasion of the second set of random access occasions is offset from one or more random access occasion of the first set of random access occasions.
Aspect 10: The method of aspect 9, wherein one or more valid random access occasions of the second set of random access occasions are non-overlapping with respective random access occasions of the first set of random access occasions.
Aspect 11: The method of any of aspects 1 through 10, further comprising: identifying one or more valid random access occasions of the first set of random access occasions, wherein the second set of random access occasions are offset from the one or more valid random access occasions of the first set of random access occasions.
Aspect 12: The method of any of aspects 1 through 11, wherein each random access occasion of the first set of random access occasions is mapped to a synchronization signal block of a set of synchronization signal blocks, the method further comprising: identifying the second set of random access occasions based at least in part on a subset of the first set of random access occasions, wherein second set of random access occasions are offset relative to the subset based at least in part on the subset being mapped to a first synchronization signal block of the set of synchronization signal blocks.
Aspect 13: The method of any of aspects 1 through 12, wherein each random access occasion of the first set of random access occasions is mapped to a synchronization signal block of a set of synchronization signal blocks, the method further comprising: identifying one or more random access occasions of the second set of random access occasions based at least in part on an index of a first synchronization signal block that is mapped to a first random access occasion of the first set of random access occasions, wherein the one or more random access occasions are each mapped to the index of the first synchronization signal block.
Aspect 14: The method of any of aspects 1 through 13, further comprising: receiving a control message indicating whether the second set of random access occasions are activated, wherein determining the second set of random access occasions is based at least in part on receiving the control message.
Aspect 15: The method of aspect 14, wherein the control message indicates the second configuration, a set of beams associated with the second set of random access occasions, a quantity of random access occasions for the second set of random access occasions, or any combination thereof.
Aspect 16: The method of any of aspects 1 through 15, wherein the first set of random access occasions is associated with a first set of preambles for transmission of the preamble message, and the second set of random access occasions is associated with a second set of preambles different from the first set of preambles.
Aspect 17: A UE for wireless communications, comprising one or more memories storing processor-executable code, and one or more processors coupled with the one or more memories and individually or collectively operable to execute the code to cause the UE to perform a method of any of aspects 1 through 16.
Aspect 18: A UE for wireless communications, comprising at least one means for performing a method of any of aspects 1 through 16.
Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. ”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components. ” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples. ” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first message indicating a first configuration associated with a random access procedure, the first configuration indicating a first set of random access occasions for transmission of a preamble message;
determine a second set of random access occasions for the transmission of the preamble message, the second set of random access occasions offset relative to the first set of random access occasions in accordance with a second configuration that is based at least in part on the first set of random access occasions; and
transmit the preamble message via at least one random access occasion of the second set of random access occasions.

2. The UE of claim 1, wherein the one or more processors are individually or collectively further operable to execute the code to cause the UE to:
receive a second message indicating the second configuration, the second configuration comprising a time offset, a frequency offset, or both, wherein the determination of the second set of random access occasions is based at least in part on the time offset, the frequency offset, or both, being applied to one or more random access occasions of the first set of random access occasions.

3. The UE of claim 2, wherein the one or more processors are individually or collectively further operable to execute the code to cause the UE to:
apply the time offset, the frequency offset, or both, to a first random access occasion of the first set of random access occasions to identify a second random access occasion of the second set of random access occasions; and
determine a set of one or more additional random access occasions of the second set of random access occasions based at least in part on the second random access occasion.

4. The UE of claim 3, wherein the set of one or more additional random access occasions is adjacent in time, frequency, or both, to the second random access occasion.

5. The UE of claim 3, wherein the one or more processors are individually or collectively further operable to execute the code to cause the UE to:
apply a second time offset, a second frequency offset, or both, to the second random access occasion in accordance with the second configuration to identify the set of one or more additional random access occasions.

6. The UE of claim 3, wherein the second random access occasion, or the set of one or more additional random access occasions, or both, are mapped to a same synchronization signal block as the first random access occasion.

7. The UE of claim 3, wherein:
the second random access occasion, or the set of one or more additional random access occasions, or both, are mapped to respective synchronization signal blocks.

8. The UE of claim 3, wherein the first set of random access occasions and the second set of random access occasions are jointly mapped to a set of synchronization signal blocks.

9. The UE of claim 1, wherein each random access occasion of the second set of random access occasions is offset from one or more random access occasion of the first set of random access occasions.

10. The UE of claim 9, wherein one or more valid random access occasions of the second set of random access occasions are non-overlapping with respective random access occasions of the first set of random access occasions.

11. The UE of claim 1, wherein the one or more processors are individually or collectively further operable to execute the code to cause the UE to:
identify one or more valid random access occasions of the first set of random access occasions, wherein the second set of random access occasions are offset from the one or more valid random access occasions of the first set of random access occasions.

12. The UE of claim 1, wherein each random access occasion of the first set of random access occasions is mapped to a synchronization signal block of a set of synchronization signal blocks, and the one or more processors are individually or collectively further operable to execute the code to cause the UE to:
identify the second set of random access occasions based at least in part on a subset of the first set of random access occasions, wherein the second set of random access occasions are offset relative to the subset based at least in part on the subset being mapped to a first synchronization signal block of the set of synchronization signal blocks.

13. The UE of claim 1, wherein each random access occasion of the first set of random access occasions is mapped to a synchronization signal block of a set of synchronization signal blocks, and the one or more processors are individually or collectively further operable to execute the code to cause the UE to:
identify one or more random access occasions of the second set of random access occasions based at least in part on an index of a first synchronization signal block that is mapped to a first random access occasion of the first set of random access occasions, wherein the one or more random access occasions are each mapped to the index of the first synchronization signal block.

14. The UE of claim 1, wherein the one or more processors are individually or collectively further operable to execute the code to cause the UE to:
receive a control message indicating whether the second set of random access occasions are activated, wherein the determination of the second set of random access occasions is based at least in part on reception the control message.

15. The UE of claim 14, wherein the control message indicates the second configuration, a set of beams associated with the second set of random access occasions, a quantity of random access occasions for the second set of random access occasions, or any combination thereof.

16. The UE of claim 1, wherein the first set of random access occasions is associated with a first set of preambles for transmission of the preamble message, and the second set of random access occasions is associated with a second set of preambles different from the first set of preambles.

17. A method for wireless communications by a user equipment (UE), comprising:
receiving a first message indicating a first configuration associated with a random access procedure, the first configuration indicating a first set of random access occasions for transmission of a preamble message;
determining a second set of random access occasions for the transmission of the preamble message, the second set of random access occasions offset relative to the first set of random access occasions in accordance with a second configuration that is based at least in part on the first set of random access occasions; and
transmitting the preamble message via at least one random access occasion of the second set of random access occasions.

18. The method of claim 17, further comprising:
receiving a second message indicating the second configuration, the second configuration comprising a time offset, a frequency offset, or both, wherein determining the second set of random access occasions is based at least in part on applying the time offset, the frequency offset, or both, to one or more random access occasions of the first set of random access occasions.

19. The method of claim 18, further comprising:
applying the time offset, the frequency offset, or both, to a first random access occasion of the first set of random access occasions to identify a second random access occasion of the second set of random access occasions; and
determine a set of one or more additional random access occasions of the second set of random access occasions based at least in part on the second random access occasion.

20. A non-transitory computer-readable medium storing code for wireless communications, the code comprising instructions executable by one or more processors to:
receive a first message indicating a first configuration associated with a random access procedure, the first configuration indicating a first set of random access occasions for transmission of a preamble message;
determine a second set of random access occasions for the transmission of the preamble message, the second set of random access occasions offset relative to the first set of random access occasions in accordance with a second configuration that is based at least in part on the first set of random access occasions; and
transmit the preamble message via at least one random access occasion of the second set of random access occasions.
